(19) United States
(12) Patent Application Publication
(10) Pub. No.: US 2019/0187977 A1
(43) Pub. Date: Jun. 20, 2019

(54) DUAL BOOT OPERATING SYSTEM INSTALLATION USING MULTIPLE REDUNDANT DRIVES

(71) Applicant: MasterCard International Incorporated, Purchase, NY (US)

(72) Inventor: Wesley Alan Szwarc, Moscow Mills, MO (US)

(21) Appl. No.: 15/848,557

(22) Filed: Dec. 20, 2017

(51) Int. Cl. G06F 9/445; G06F 8/61; G06F 9/44

(52) U.S. Cl. CPC G06F 8/665; G06F 8/63; G06F 9/441; G06F 8/61

(57) ABSTRACT

The disclosure herein describes installing operating system (OS) software of a computing device with multiple redundant drives. A first drive is removed from a redundant drive array mirroring the first drive and a second drive, the drives including a first OS. The first drive is formatted to remove the first OS and include a plurality of partitions. Installation data is mounted on an installation partition of the first drive, the installation data configured to install a second OS. A bootloader component is updated to include an installation option for the second OS. The second OS is then installed on the plurality of partitions of the first drive based on the installation data. The plurality of partitions are configured as multiple virtual redundant drives with respect to the second OS, whereby the computing device is enabled to boot to either the first OS or the second OS.

### BACKGROUND

Updating operating system (OS) software on client computing devices that have high uptime and reliability requirements results in challenges that must be addressed. Updating the OS software may require that the computing device be rebooted several times, resulting in significant downtime. Further downtime may be incurred when the device is in the midst of an installation process and/or when the functionality and/or stability of the updated OS software is being verified. Additionally, updating OS software may result in remnants or other elements of the current OS software being leftover or dormant on the device, which results in wasted drive space and may interfere with the functionality of the device.

If, after updating the OS software, it is found that the update was not appropriate (e.g., the new OS does not provide the desired functionality, the new OS is not stable on the device, etc.), reverting to the previous OS software and/or configuration for the purpose of diagnostics, analysis, or retrying the update may be difficult and require additional downtime. Updating OS software quickly and cleanly is a high priority for maintaining uptime and reliable functionality on client computing devices.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

A computerized method for updating operating system (OS) software of a computing device with multiple redundant drives, the method comprising removing a first drive from a redundant drive array mirroring the first drive and a second drive, the first drive and second drive including a first OS. The first drive is formatted to remove the first OS and include a plurality of partitions. Installation data is mounted on an installation partition of the plurality of partitions of the first drive, the installation data configured to install a second OS. A bootloader component is updated to include an installation option associated with the mounted installation data. The second OS is then installed on the plurality of partitions of the first drive based on the installation data. The plurality of partitions are configured as multiple virtual redundant drives with respect to the second OS, whereby the computing device is enabled to boot to the second OS on the first drive or the first OS on the second drive.

Many of the attendant features will be more readily appreciated as the same becomes better understood by reference to the following detailed description considered in connection with the accompanying drawings.

### BRIEF DESCRIPTION OF THE DRAWINGS

The present description will be better understood from the following detailed description read in light of the accompanying drawings, wherein:

FIG. 1 is an exemplary block diagram illustrating a system of devices including client devices with redundant drives according to an embodiment;

FIGS. 2A-2B are exemplary block diagrams illustrating states of a client device with redundant drives before and after installation of an operating system according to an embodiment;

FIG. 3 is an exemplary flow chart illustrating installation of an operating system on one drive of a client device according to an embodiment;

FIG. 4 is an exemplary flow chart illustrating installation of an updated operating system on one drive and selection to complete the installation on a second drive or revert the installation according to an embodiment; and

FIG. 5 illustrates a computing apparatus according to an embodiment as a functional block diagram.

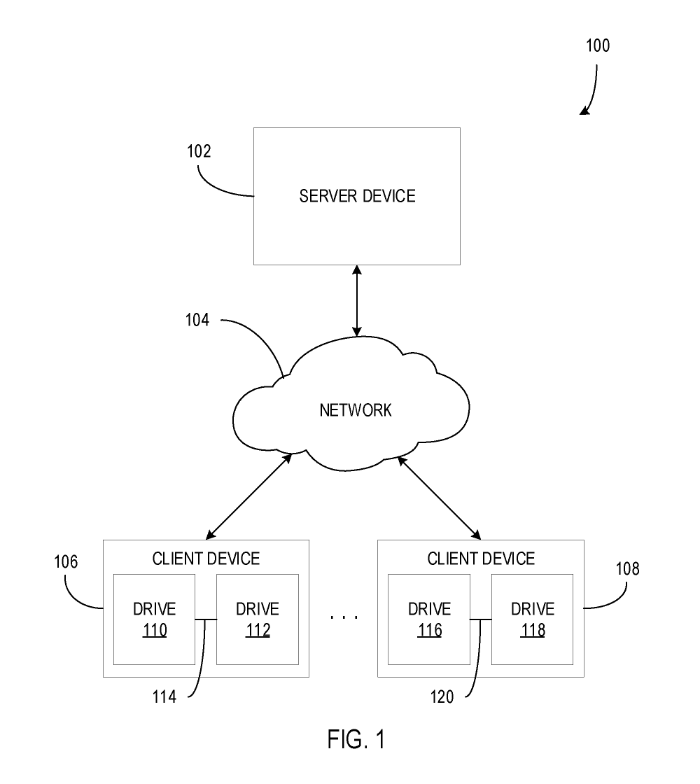

Corresponding reference characters indicate corresponding parts throughout the drawings. In FIGS. 1 to 5, the systems are illustrated as schematic drawings. The drawings may not be to scale.

### DETAILED DESCRIPTION

Aspects of the disclosure provide a system and method for updating operating system (OS) software on a computing device using multiple redundant drives. The computing device is configured to dual boot to either the updated OS software or the current OS software. A first drive is temporarily removed from a redundant drive array mirroring the first drive and a second drive. The first drive and second drive initially include a first OS. The first drive is formatted to remove the first OS and include a plurality of partitions. Installation data configured to install a second OS, or updated OS, is mounted on an installation partition of the first drive. A bootloader component is updated to include an installation option associated with the mounted installation data. Based on the installation option, the second OS is installed on the plurality of partitions of the first drive, the plurality of partitions being configured as multiple virtual redundant drives with respect to the second OS, whereby the computing device is enabled to boot to the second OS on the first drive or the first OS on the second drive. After the second OS is installed on the first drive, a user or administrator is able to test out the second OS for functionality, compatibility, security, etc. If the second OS proves acceptable, the user completes the installation of the second OS onto the second drive. If the second OS is deemed unacceptable, the user may revert back to the first OS using the first OS installation remaining on the second drive. In either case, the mirroring between the first and second drives within the redundant drive array is then restored.

The use of the described method provides an efficient installation of a clean version of the new or updated OS. The number of required reboots may be reduced by using a clean, complete image of the new or updated OS. Further, by installing the new or updated OS onto one drive of multiple redundant drives and enabling a user to boot to either OS, the new or updated OS may be tested for functionality and stability while maintaining the capability to quickly fall back to the previous OS in case of failure. The installation of the new OS or reversion back to the previous OS may be completed as described herein depending on a decision of a user of the device. Additionally, the described method enables the new or updated OS to be installed to a drive from an image on the same drive, such that additional install media (e.g., an install CD, universal serial bus (USB) drive, or the like) are not necessary.

FIG. 1 is an exemplary block diagram illustrating a system 100 of devices including client devices 106 and 108 with redundant drives 110, 112, 116, and 118 according to an embodiment. A server device 102 (e.g., a computing device as described herein, etc.) is connected to the client devices 106 and 108 by a network 104. The network 104 may include the Internet, a private intranet, a combination of different networks, or the like. While the system 100 includes two client devices 106-108, alternative examples of a system may include more, fewer, and/or differently arranged client devices without departing from the description herein.

In an example, the client devices 106-108 are located at one or more sites and are configured to automatically collect data (e.g., credit card transaction data, etc.), execute applications, scripts, or the like, and/or communicate data to and from the server device 102 and/or other client devices. The server device 102 is configured to communicate with and manage the client devices 106-108 via the network 104. The server device 102 may be used to collect transaction data from the client devices 106-108, collect logs or performance data from the client devices 106-108, and/or reconfigure, install, or update software on the client devices 106-108. The client devices 106-108 may be configured to be managed by the server device 102 over the network 104 or via on-site user interfaces (e.g., keyboard, mouse, display screen, etc.). However, in some examples, the client devices 106-108 may lack some or all on-site user interfaces, such that management is only possible through the use of the server device 102 or other device connected via the network 104.

The drives 110 and 112 are mirrored (e.g., data is stored redundantly on both drives, etc.) by the redundant drive array 114 and the drives 116 and 118 are mirrored by the redundant drive array 120. Redundant drive arrays (e.g., a redundant array of independent disks (RAID), etc.) provide improved security of the data stored thereon, preventing loss of data in the case of failure of one of the drives. Further, redundant drive arrays may provide improved hard drive performance with respect to reading and/or writing data. The redundant drive arrays 114 and 120, represented by lines between the associated drives, may be software components configured to monitor commands for writing to and/or reading from the associated drives (e.g., redundant drive array 114 monitors the commands associated with drives 110 and 112, etc.) and, in response to the monitored commands, enforce mirroring and/or synchronization of the data on both drives. While the client devices 106-108 include two drives each, it should be understood that, in other examples, client devices may include more and/or differently arranged drives without departing from the description herein.

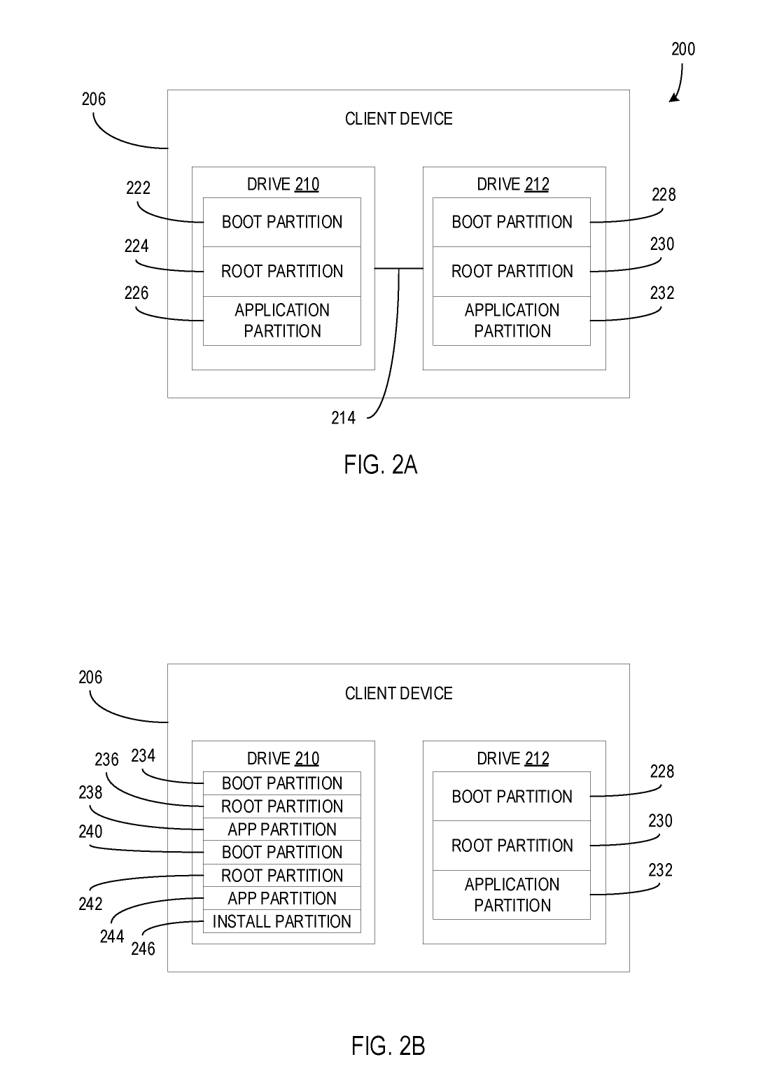

FIGS. 2A-2B are exemplary block diagrams illustrating states of a client device with redundant drives before and after installation of an operating system according to an embodiment. In FIG. 2A, client device 206 includes drives 210 and 212 that are mirrored by the redundant drive array 214. Drive 210 includes a boot partition 222, a root partition 224, and an application partition 226. Drive 212 includes a boot partition 228, a root partition 230, and an application partition 232. The boot partitions 222 and 228, root partitions 224 and 230, and application partitions 226 and 232 are mirrored via the redundant drive array 214 as described above. However, the disclosure is operable with other quantities and types of partitions that may be mirrored.

Boot partitions include data required for booting up the associated computing device. For instance, a boot partition may include a bootloader (e.g., software responsible for booting the operating system of the computing device, such as the Grand Unified Bootloader (GRUB), etc.). Other boot partition data may include kernel files, hardware initialization files, and other associated boot data. Root partitions include the top level of the file directory of the system and may further include files and data associated with the operating system and/or other core system functionality. Application partitions include data and files associated with applications installed or otherwise stored on the drive.

In some examples, a user (e.g., an engineer, technician, etc.) may install a new operating system (OS), updated version of a current OS, or the like. The installation process, as described herein, includes installing the new OS onto one of the drives (e.g., drive 210, etc.) of the client device 206 while maintaining the current OS on the other drive (e.g., drive 212, etc.) and configure the client device 206 to be able to boot into both the new OS and the current OS, providing the user the ability to test the new OS while preserving the current OS configuration. If the user determines that the new OS configuration is sufficiently function and/or stable, the installation may be completed by mirroring the new OS onto the other drive with a redundant drive array. Alternatively, if the user determines that the new OS configuration is not sufficiently functional and/or stable, the drive with the new OS may be reverted to the current OS configuration (e.g., the state shown in FIG. 2A, etc.).

FIG. 2B illustrates the state of the client device 206 after a new OS or updated OS version is installed on drive 210 and the current OS is maintained on drive 212. The new OS is configured to be installed on two drives mirrored with a redundant drive array. In order to correctly install the new OS, the drive 210 is formatted to remove the partitions 222, 224, and 226 and new partitions 234, 236, 238, 240, 242, 244, and 246 are created thereon. The new OS is installed on the new partitions as if partitions 234, 236, and 238 are a first virtual drive and partitions 240, 242, and 244 are a second virtual drive. The first and second virtual drives are mirrored using a redundant drive array as described herein, such that the installed new OS is configured to function with mirrored drives. The installation partition, or install partition, 246 may be created to store backup data from the previous installation on the drive, an image file of the new OS (e.g., a .iso file, etc.), a kickstart file or data used during installation, scripts that are needed for the installation, etc.

In some example, more, fewer, or different partitions may be used on the drive without departing from the description. For instance, different software, firmware, and/or hardware configurations may call for alternative partition configurations. The partition configuration described herein may be used with a system configured for use with a legacy firmware mode, while additional partitions may be used when the system is configured with an extensible firmware interface (EFI) or other similar firmware configurations.

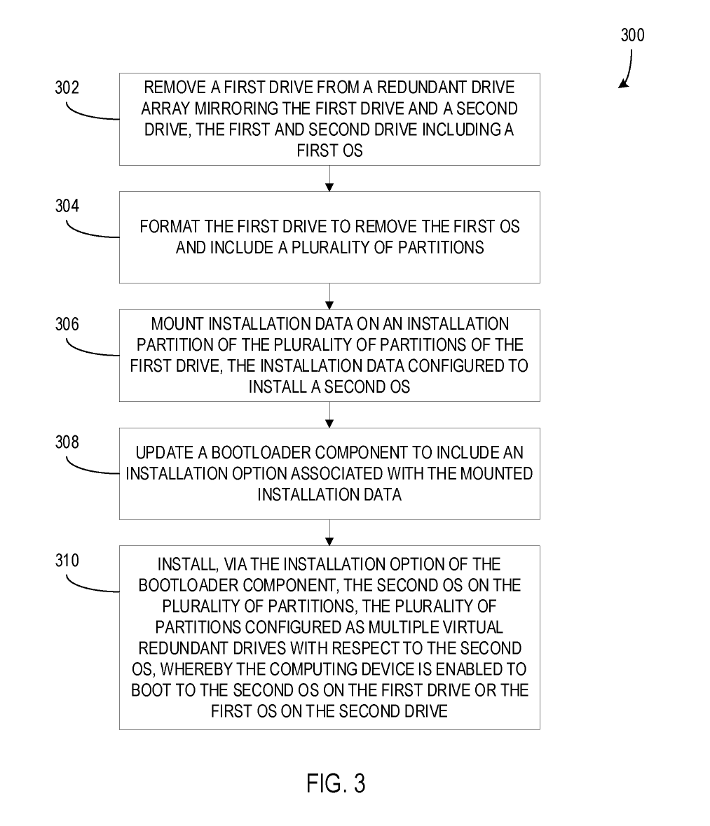

FIG. 3 is an exemplary flow chart illustrating installation of an operating system on one drive 210 of a client device 206 according to an embodiment. At 302, a first drive (e.g., drive 210, etc.) is removed from a redundant drive array (e.g., redundant drive array 214, etc.) mirroring the first drive and a second drive (e.g., the redundant drive array is configured to cause the first and second drives to store identical data prior to the first drive being removed). The first and second drive include a first OS as described herein. Upon removing the first drive from the redundant drive array, the contents of the first and second drives are no longer synchronized based on writes and/or reads of one of the drives. For instance, exemplary LINUX code commands are shown below for removing the first drive, including associated partitions (e.g., /dev/sda3, /dev/sda2, and/dev/sda1, etc.), from the redundant drive array.

mdadm --manage /dev/md2 -f /dev/sda3
mdadm --manage /dev/md2 -r /dev/sda3
mdadm --manage /dev/md1 -f /dev/sda2
mdadm --manage /dev/md1 -r /dev/sda2
mdadm --manage /dev/md0 -f /dev/sda1
mdadm --manage /dev/md0 -r /dev/sda1

At 304, the first drive is formatted to remove the first OS and include a plurality of partitions. For instance, the partitions 234-246 may be created on the drive 210 after formatting the partitions 222-226 as shown in FIGS. 2A-2B. Additionally, the redundant drive array may be reconfigured to not include the first drive, shrinking the redundant drive array to a one drive mirror that includes only the second drive. This enables the computing device to boot to the first OS without use of the first drive. For instance, exemplary code commands for formatting the first drive with a new plurality of partitions are provided below.

sfdisk -f /dev/sda < PartitionTable.txt
partprobe /dev/sda
mkfs.ext4 /dev/sda1

In some examples, prior to shrinking the redundant drive array to a one drive mirror, the newly formatted first partition of the first disk is added to back to the redundant drive array to ensure that the computing device can be booted properly, as shown in the exemplary code command below.
mdadm--manage/dev/md0-a/dev/sda1

Shrinking the redundant drive array to a one drive mirror, which may require the newly formatted first partition to be removed from the redundant drive array as described above, may be based, at least on in part, on the exemplary code commands below.

mdadm --grow --raid-device=1 /dev/md0 -force
mdadm --grow --raid-device=1 /dev/md1 -force
mdadm --grow --raid-device=1 /dev/md2 -force

At 306, installation data configured to install a second OS (e.g., a different OS from the first OS, a different and/or more recent version of the first OS, etc.) is mounted on an installation partition (e.g., installation partition 246, etc.) of the plurality of partitions of the first drive. The installation data may include an image file for installation of the second OS, a kickstart file, installation scripts, backed up data from the previous OS installation, etc. For instance, exemplary code commands for configuring the installation partition are provided below, including copying an installation image and a kickstart file to the installation partition, as well as configuring a virtual compact disk drive directory (/cdrom) for mounting the installation image.

mkfs.ext2 /dev/sda8
mkdir /osinstall
mount /dev/sda8 /osinstall
cp installation.iso /osinstall/
cp kickstart.cfg /osinstall/
mkdir /cdrom
mount -o loop installation.iso /cdrom
cp -R /cdrom/* /osinstall/

At 308, a bootloader component is updated to include an installation option associated with the mounted installation data. The bootloader may enable a selection of options upon booting up the associated computing device. For instance, upon booting up the computing device, the bootloader may enable a user to choose to boot into the first OS and/or install the second OS from the mounted installation partition. In an example, the bootloader (e.g., the Grand Unified Bootloader (GRUB), etc.) is updated with the installation option using, at least in part, the exemplary code commands shown below.

cat >> /etc/grub.conf <<EOF
title Linux 7.3 Installation
root (hd0,7)
kernel /isolinux/vmlinuz linux
inst.stage2=hd:sda8:/LiveOS/squashfs.img
ks=hd:sda8:/mip-ks.cfg inst.repo=hd:sda8:/
initrd /isolinux/initrd.img
EOF

In a further example, the Grand Unified Bootloader (GRUB) is used and configured according to the exemplary code commands shown below.

mv /boot/grub/device.map /boot/grub/device.map.bak
grub --device-map=/boot/grub/device.map <<EOF
grub-install /dev/sda
grub-install /dev/sdb
setup grub
root (hd0,0)
setup (hd0)
root (hd1,0)
setup (hd1)

At 310, the second OS is installed via the installation option of the bootloader component. The installation includes configuring the plurality of partitions (e.g., partitions 234-244, etc.) as multiple virtual redundant drives with respect to the second OS, whereby the associated computing device is enabled to boot to the second OS on the first drive or the first OS on the second drive. For instance, as shown in FIG. 2B, the partitions 234-238 are configured as a first virtual drive and the partitions 240-244 are configured as a second virtual drive and they are mirrored with a redundant drive array component. Exemplary code commands for configuring the plurality of partitions are provided below.

dd if=/dev/zero of=/dev/sda1 bs=512 count=2
dd if=/dev/zero of=/dev/sda2 bs=512 count=2
dd if=/dev/zero of=/dev/sda3 bs=512 count=2
dd if=/dev/zero of=/dev/sda5 bs=512 count=2
dd if=/dev/zero of=/dev/sda6 bs=512 count=2
dd if=/dev/zero of=/dev/sda7 bs=512 count=2
mkfs.ext4 /dev/sda1
mkfs.ext4 /dev/sda2
mkfs.ext4 /dev/sda3
mkfs.ext4 /dev/sda5
mkfs.ext4 /dev/sda6
mkfs.ext4 /dev/sda7

Further, exemplary code commands for configuring the mirror of the virtual redundant drives using a redundant drive array are provided below.

| part raid.01 --asprimary | | --fstype=“mdmember” -- |
|---|---|---|
| onpart=sda1 | | --size=512 |
| part raid.02 | | --fstype=“mdmember” -- |
| grow | --onpart=sda3 | --size=1 |
| part raid.03 | | --fstype=“mdmember” -- |
| grow | --onpart=sda5 | --size=1 |
| part raid.11 --asprimary | | --fstype=“mdmember” -- |
| onpart=sda2 | | --size=512 |
| part raid.12 | | --fstype=“mdmember” -- |
| grow | --onpart=sda6 | --size=1 |
| part raid.13 | | --fstype=“mdmember” -- |
| grow | --onpart=sda7 | --size=1 |

| | | |
|---|---|---|
| raid /boot | --fstype=“ext4” --level=1 | -- |

| device=md4 raid.01 raid.11 | |
|---|---|
| raid pv.01 | --fstype=“lvmpv” --level=RAID1 -- |
| device=md5 raid.02 raid.12 | |
| raid pv.02 | --fstype=“lvmpv” --level=RAID1 -- |

device=md6 raid.03 raid.13

In some examples, the bootloader component is further configured to include an option to boot into the second OS as well as the first OS after the second OS is installed. Upon booting into the second OS, a user of the associated computing device may use the second OS to test that the installation of the second OS is stable and that the second OS provides the functionality required by the computing device. For instance, a user may execute tests on the computing device to confirm that the second OS provides appropriate functionality and stability, that required applications are compatible with the second OS installation, and/or that the multiple virtual redundant drives are functioning. In further examples, after the functionality of the multiple virtual redundant drives is verified, the redundant drive array mirroring the virtual redundant drives may be deactivated, disabled, or otherwise reconfigured to break the mirror between the multiple virtual redundant drives to prevent thrashing of the drive when testing.

Further, the installation process may be executed using a kickstart file installed on the installation partition of the drive described above. For instance, the kickstart file may include code and/or script that causes the computing device to format the drive with the required partitions (e.g., partitions 234-244, etc.), set up the redundant drive array for mirroring the virtual redundant drive partitions, and breaking the mirror after testing the redundant virtual drives if necessary.

It should be understood that code commands provided herein are merely examples and not limiting. More, fewer, equivalent, or different code commands may be used to implement the described methods without departing from the scope of the disclosure.

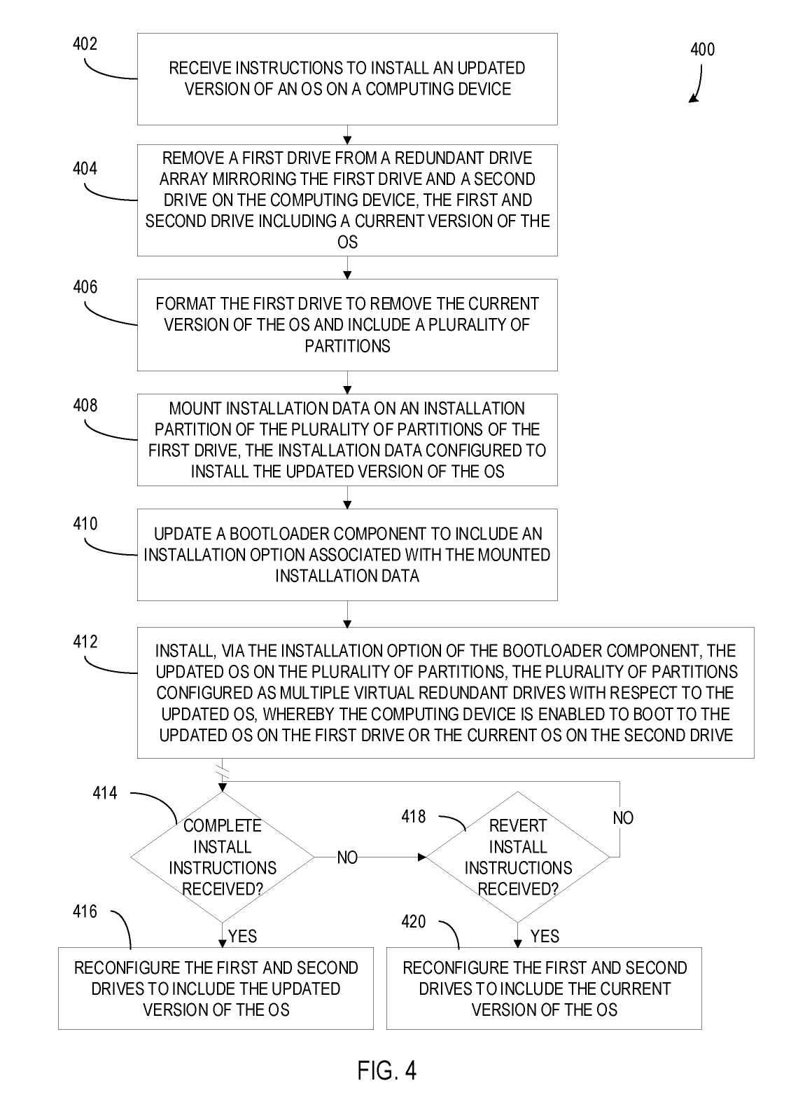

FIG. 4 is an exemplary flow chart illustrating installation of an updated operating system on one drive and selection to complete the installation on a second drive or revert the installation according to an embodiment. At 402, a computing device receives instructions to install an updated version of an OS. In some examples, the instructions may be received via a user interface of the computing device. Alternatively, the instructions may be received via a network interface of the computing device (e.g., client device 106 receiving instructions to install an updated version of an OS over the network 104 from the server device 102, etc.). From 404 to 412, the updated version of the OS is installed on a first drive in a substantially identical process as described above with respect to FIG. 3.

At a later time, at 414, the computing device may receive instructions to complete the installation of the updated version of the OS. A user of the computing device may choose to complete the installation of the updated version of the OS or revert back to the current version of the OS. If install completion instructions are received, at 416, the first and second drives are reconfigured to include the updated version of the OS. Further, the first and second drives may be mirrored by a redundant drive array again, such that the device functions as the client device 206 shown in FIG. 2A, but with an updated version of the OS installed on the mirrored drives. In some examples, the reconfiguration of the first and second drives includes breaking the mirror between the first and second virtual drives on the first drive, formatting the second drive to be a mirror of the first drive using a redundant drive array, copying data from the first drive into the newly formatted second drive to synchronize the drives, and updating a bootloader component to include an option to boot into the new version of the OS as installed on the first and second drives and to remove other boot options for which the drives are no longer configured.

Alternatively, if instructions to complete the install are not received at 414, instructions to revert the install to the older version of the OS may be received at 418. If instructions to revert the install are not received, the computing device may continue to wait for instructions to complete the install or revert the install while device is configured for dual booting. If instructions to revert the install are received at 418, the first and second drives may be reconfigured to include the current version of the OS at 420. In some examples, the reconfiguration of the first and second drives includes formatting the first drive to be a mirror of the second drive using a redundant drive array, copying data from the second drive into the newly formatted first drive to synchronize the drives, and updating the bootloader component to include the option to boot into the current version of the OS and to remove other boot options for which the drives are no longer configured.

### Additional Example Scenarios

Aspects of the disclosure enable various additional scenarios, such as next described.

In an example, a user initiates an OS update on a client device from a LINUX OS, version 6.8, to the LINUX OS, version 7.3. The client device includes mirrored drives as described herein. The client device removes one of the drives from the mirror and formats and partitions the removed drive to prepare it for installation of LINUX 7.3. A GRUB bootloader component is updated to include a LINUX 7.3 install option. The last partition on the formatted drive is configured to include a LINUX 7.3 install image and a kickstart file. The mirror associated with the unformatted drive is shrunk to a single drive mirror. The client device may then reboot and the user selects the LINUX 7.3 install option. The kickstart file includes commands that cause the device to complete the formatting of the partitions of the formatted drive for use by the LINUX 7.3, including partitions for multiple virtual redundant drives. LINUX 7.3 is installed on the multiple virtual redundant drives, which are mirrored via a redundant drive array. After the install is completed and the virtual redundant drives, the mirror is broken to prevent thrashing of the drives.

In a further example, the user boots into the newly installed LINUX 7.3. Upon determining that the newly installed OS is functioning appropriately, the user selects to complete the installation of LINUX 7.3. The device reconfigures the LINUX 7.3 drive to include only one set of partitions (e.g., removing one of the virtual redundant drives, resizing partitions, etc.) and formats the LINUX 6.8 drive to prepare for synchronization with the LINUX 7.3 drive. The LINUX 7.3 drive and LINUX 6.8 drive are joined by a redundant drive array and the data on the LINUX 7.3 drive is mirrored onto the previously LINUX 6.8 drive.

In an alternative example, the user boots into a newly installed LINUX 7.3 OS. Upon determining that the newly installed OS is not functioning appropriately, the user selects to revert the installation to LINUX 6.8. The device formats the LINUX 7.3 drive to prepare it for synchronization with the LINUX 6.8 drive. The LINUX 7.3 drive and LINUX 6.8 drive are joined by a redundant drive array and the data on the LINUX 6.8 drive is mirrored onto the previously LINUX 7.3 drive.

Exemplary Operating Environment

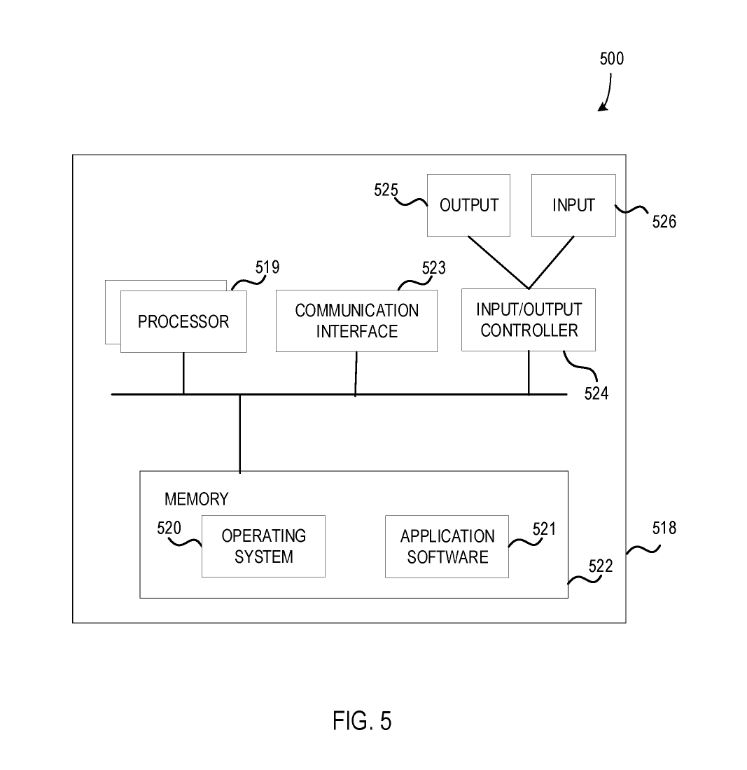

The present disclosure is operable with a computing apparatus according to an embodiment as a functional block diagram 500 in FIG. 5. In an embodiment, components of a computing apparatus 518 may be implemented as a part of an electronic device according to one or more embodiments described in this specification. The computing apparatus 518 comprises one or more processors 519 which may be microprocessors, controllers or any other suitable type of processors for processing computer executable instructions to control the operation of the electronic device. Platform software comprising an operating system 520 or any other suitable platform software may be provided on the apparatus 518 to enable application software 521 to be executed on the device. According to an embodiment, installing a new and/or updated OS on a system including multiple redundant drives may be accomplished by software.

Computer executable instructions may be provided using any computer-readable media that are accessible by the computing apparatus 518. Computer-readable media may include, for example, computer storage media such as a memory 522 and communications media. Computer storage media, such as a memory 522, include volatile and non-volatile, removable and non-removable media implemented in any method or technology for storage of information such as computer readable instructions, data structures, program modules or the like. Computer storage media include, but are not limited to, RAM, ROM, EPROM, EEPROM, flash memory or other memory technology, CD-ROM, digital versatile disks (DVD) or other optical storage, magnetic cassettes, magnetic tape, magnetic disk storage or other magnetic storage devices, or any other non-transmission medium that can be used to store information for access by a computing apparatus. In contrast, communication media may embody computer readable instructions, data structures, program modules, or the like in a modulated data signal, such as a carrier wave, or other transport mechanism. As defined herein, computer storage media do not include communication media. Therefore, a computer storage medium should not be interpreted to be a propagating signal per se. Propagated signals per se are not examples of computer storage media. Although the computer storage medium (the memory 522) is shown within the computing apparatus 518, it will be appreciated by a person skilled in the art, that the storage may be distributed or located remotely and accessed via a network or other communication link (e.g. using a communication interface 523).

The computing apparatus 518 may comprise an input/output controller 524 configured to output information to one or more output devices 525, for example a display or a speaker, which may be separate from or integral to the electronic device. The input/output controller 524 may also be configured to receive and process an input from one or more input devices 526, for example, a keyboard, a microphone or a touchpad. In one embodiment, the output device 525 may also act as the input device. An example of such a device may be a touch sensitive display. The input/output controller 524 may also output data to devices other than the output device, e.g. a locally connected printing device. In some embodiments, a user may provide input to the input device(s) 526 and/or receive output from the output device(s) 525.

The functionality described herein can be performed, at least in part, by one or more hardware logic components. According to an embodiment, the computing apparatus 518 is configured by the program code when executed by the processor 519 to execute the embodiments of the operations and functionality described. Alternatively, or in addition, the functionality described herein can be performed, at least in part, by one or more hardware logic components. For example, and without limitation, illustrative types of hardware logic components that can be used include Field-programmable Gate Arrays (FPGAs), Application-specific Integrated Circuits (ASICs), Program-specific Standard Products (ASSPs), System-on-a-chip systems (SOCs), Complex Programmable Logic Devices (CPLDs), Graphics Processing Units (GPUs).

At least a portion of the functionality of the various elements in the figures may be performed by other elements in the figures, or an entity (e.g., processor, web service, server, application program, computing device, etc.) not shown in the figures.

Although described in connection with an exemplary computing system environment, examples of the disclosure are capable of implementation with numerous other general purpose or special purpose computing system environments, configurations, or devices.

Examples of well-known computing systems, environments, and/or configurations that may be suitable for use with aspects of the disclosure include, but are not limited to, mobile or portable computing devices (e.g., smartphones), personal computers, server computers, hand-held (e.g., tablet) or laptop devices, multiprocessor systems, gaming consoles or controllers, microprocessor-based systems, set top boxes, programmable consumer electronics, mobile telephones, mobile computing and/or communication devices in wearable or accessory form factors (e.g., watches, glasses, headsets, or earphones), network PCs, minicomputers, mainframe computers, distributed computing environments that include any of the above systems or devices, and the like. In general, the disclosure is operable with any device with processing capability such that it can execute instructions such as those described herein. Such systems or devices may accept input from the user in any way, including from input devices such as a keyboard or pointing device, via gesture input, proximity input (such as by hovering), and/or via voice input.

Examples of the disclosure may be described in the general context of computer-executable instructions, such as program modules, executed by one or more computers or other devices in software, firmware, hardware, or a combination thereof. The computer-executable instructions may be organized into one or more computer-executable components or modules. Generally, program modules include, but are not limited to, routines, programs, objects, components, and data structures that perform particular tasks or implement particular abstract data types. Aspects of the disclosure may be implemented with any number and organization of such components or modules. For example, aspects of the disclosure are not limited to the specific computer-executable instructions or the specific components or modules illustrated in the figures and described herein. Other examples of the disclosure may include different computer-executable instructions or components having more or less functionality than illustrated and described herein.

In examples involving a general-purpose computer, aspects of the disclosure transform the general-purpose computer into a special-purpose computing device when configured to execute the instructions described herein.

Alternatively, or in addition to the other examples described herein, examples include any combination of the following:

A system for updating operating system (OS) software of a computing device with multiple redundant drives comprising:
at least one processor;
a first drive and a second drive, the first and second drive mirrored via a redundant drive array; and
at least one memory comprising computer program code, the at least one memory and the computer program code configured to, with the at least one processor, cause the at least one processor to:
remove the first drive from the redundant drive array mirroring the first drive and a second, the first drive and second drive including a first OS;
format the first drive to remove the first OS and include a plurality of partitions;
mount installation data on an installation partition of the plurality of partitions of the first drive, the installation data configured to install a second OS;
update a bootloader component of the computing device to include an installation option associated with the mounted installation data; and
install, via the installation option of the bootloader component, the second OS on the plurality of partitions of the first drive based on the installation data, the plurality of partitions being configured as multiple virtual redundant drives with respect to the second OS, whereby the computing device is enabled to boot to the second OS on the first drive or the first OS on the second drive.

The system described above, the at least one memory and the computer program code configured to, with the at least one processor, further cause the at least one processor to:
receive instructions indicating to install the second OS on the second drive; and
in response to the received instructions, reconfigure the first drive to include partitions of a single drive upon which the second OS is installed and reconfigure to second drive to mirror the first drive based on the redundant drive array.

The system described above, wherein the second OS is an updated version of the first OS.

The system described above, the at least one memory and the computer program code configured to, with the at least one processor, further cause the at least one processor to rebuild the bootloader component to support booting to the second OS on the first drive and the first OS on the second drive.

The system described above, the at least one memory and the computer program code configured to, with the at least one processor, further cause the at least one processor to install the rebuilt bootloader component on the first drive and the second drive.

The system described above, wherein installing the second OS on the plurality of partitions of the first drive based on the installation data includes installing a second redundant drive array mirroring the multiple virtual redundant drives of the first drive; and
the at least one memory and the computer program code configured to, with the at least one processor, further cause the at least one processor to disable the second redundant drive array after installing the second OS.

The system described above, wherein the first drive and second drive include boot partitions, root partitions, and application partitions.

The system described above, wherein mounting installation data on the installation partition includes mounting an installation image and a kickstart file on the installation partition; and
wherein installing the second OS includes configuring, based on the kickstart file, a first two partitions of the plurality of partitions as boot partitions, configuring a second two partitions of the plurality of partitions as root partitions, and configuring a third two partitions of the plurality of partitions as application partitions on the first drive.

A computerized method for updating operating system (OS) software of a computing device with multiple redundant drives, the method comprising:
removing a first drive from a redundant drive array mirroring the first drive and a second drive, the first drive and second drive including a first OS;
formatting the first drive to remove the first OS and include a plurality of partitions;
mounting installation data on an installation partition of the plurality of partitions of the first drive, the installation data configured to install a second OS;
updating a bootloader component to include an installation option associated with the mounted installation data; and
installing, via the installation option of the bootloader component, the second OS on the plurality of partitions of the first drive based on the installation data, the plurality of partitions configured as multiple virtual redundant drives with respect to the second OS, whereby the computing device is enabled to boot to the second OS on the first drive or the first OS on the second drive.

The computerized method described above, further comprising:
receiving instructions indicating to install the second OS on the second drive; and
in response to the received instructions, reconfiguring the first drive to include partitions of a single drive upon which the second OS is installed and reconfiguring to second drive to mirror the first drive based on the redundant drive array.

The computerized method described above, wherein the second OS is an updated version of the first OS.

The computerized method described above, further comprising rebuilding the bootloader component to support booting to the second OS on the first drive and the first OS on the second drive.

The computerized method described above, further comprising installing the rebuilt bootloader component on the first drive and the second drive.

The computerized method described above, wherein installing the second OS on the plurality of partitions of the first drive based on the installation data includes installing a second redundant drive array mirroring the multiple virtual redundant drives of the first drive; and
the method further comprising disabling the second redundant drive array after installing the second OS.

The computerized method described above, wherein the first drive and second drive include boot partitions, root partitions, and application partitions.

The computerized method described above, wherein mounting installation data on the installation partition includes mounting an installation image and a kickstart file on the installation partition; and
wherein installing the second OS includes configuring, based on the kickstart file, a first two partitions of the plurality of partitions as boot partitions, configuring a second two partitions of the plurality of partitions as root partitions, and configuring a third two partitions of the plurality of partitions as application partitions on the first drive.

One or more computer storage media having computer-executable instructions for updating operating system (OS) software of a computing device with multiple redundant drives that, upon execution by a processor, cause the processor to at least:
remove a first drive from a redundant drive array mirroring the first drive and a second drive of the computing device, the first drive and second drive including a first OS;
format the first drive to remove the first OS and include a plurality of partitions;
mount installation data on an installation partition of the plurality of partitions of the first drive, the installation data configured to install an updated OS to multiple redundant drives;
update a bootloader component of the computing device to include an installation option associated with the mounted installation data; and
install, via the installation option of the bootloader component, the updated OS on the plurality of partitions of the first drive based on the installation data, the plurality of partitions configured as multiple virtual redundant drives with respect to the updated OS, whereby the computing device is enabled to boot to the updated OS on the first drive or the first OS on the second drive.
   The one or more computer storage media described above, the computer-executable instructions, upon execution by a processor, further causing the processor to:
receive instructions indicating to install the updated OS on the second drive; and
in response to the received instructions, reconfigure the first drive to include partitions of a single drive upon which the updated OS is installed and reconfiguring to second drive to mirror the first drive based on the redundant drive array.

The one or more computer storage media described above, the computer-executable instructions, upon execution by a processor, further causing the processor to rebuild the bootloader component to support booting to the updated OS on the first drive and the first OS on the second drive.

The one or more computer storage media described above, wherein mounting installation data on the installation partition includes mounting an installation image and a kickstart file on the installation partition; and
wherein installing the updated OS includes configuring, based on the kickstart file, a first two partitions of the plurality of partitions as boot partitions, configuring a second two partitions of the plurality of partitions as root partitions, and configuring a third two partitions of the plurality of partitions as application partitions on the first drive.

Any range or device value given herein may be extended or altered without losing the effect sought, as will be apparent to the skilled person.

While no personally identifiable information is tracked by aspects of the disclosure, examples have been described with reference to data monitored and/or collected from the users. In some examples, notice may be provided to the users of the collection of the data (e.g., via a dialog box or preference setting) and users are given the opportunity to give or deny consent for the monitoring and/or collection. The consent may take the form of opt-in consent or opt-out consent.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

It will be understood that the benefits and advantages described above may relate to one embodiment or may relate to several embodiments. The embodiments are not limited to those that solve any or all of the stated problems or those that have any or all of the stated benefits and advantages. It will further be understood that reference to ‘an’ item refers to one or more of those items.

The embodiments illustrated and described herein as well as embodiments not specifically described herein but within the scope of aspects of the claims constitute exemplary means for installing a new or updated OS on a device with multiple redundant drives and enabling the device to dual boot to both the new OS and the previous OS. The illustrated one or more processors 519 together with the computer program code stored in memory 522 constitute exemplary processing means for installing a new or update OS on one drive of multiple redundant drives, thereby maintaining the capability to boot to and/or revert to the previous OS.

The term “comprising” is used in this specification to mean including the feature(s) or act(s) followed thereafter, without excluding the presence of one or more additional features or acts.

In some examples, the operations illustrated in the figures may be implemented as software instructions encoded on a computer readable medium, in hardware programmed or designed to perform the operations, or both. For example, aspects of the disclosure may be implemented as a system on a chip or other circuitry including a plurality of interconnected, electrically conductive elements.

The order of execution or performance of the operations in examples of the disclosure illustrated and described herein is not essential, unless otherwise specified. That is, the operations may be performed in any order, unless otherwise specified, and examples of the disclosure may include additional or fewer operations than those disclosed herein. For example, it is contemplated that executing or performing a particular operation before, contemporaneously with, or after another operation is within the scope of aspects of the disclosure.

When introducing elements of aspects of the disclosure or the examples thereof, the articles “a,” “an,” “the,” and “said” are intended to mean that there are one or more of the elements. The terms “comprising,” “including,” and “having” are intended to be inclusive and mean that there may be additional elements other than the listed elements. The term “exemplary” is intended to mean “an example of” The phrase “one or more of the following: A, B, and C” means “at least one of A and/or at least one of B and/or at least one of C.”

Having described aspects of the disclosure in detail, it will be apparent that modifications and variations are possible without departing from the scope of aspects of the disclosure as defined in the appended claims. As various changes could be made in the above constructions, products, and methods without departing from the scope of aspects of the disclosure, it is intended that all matter contained in the above description and shown in the accompanying drawings shall be interpreted as illustrative and not in a limiting sense.

1. A system for updating operating system (OS) software of a computing device with multiple redundant drives comprising:
at least one processor;
a first drive and a second drive, the first drive and the second drive mirrored via a redundant drive array; and
at least one memory comprising computer program code, the at least one memory and the computer program code configured to, with the at least one processor, cause the at least one processor to:
remove the first drive from the redundant drive array, the redundant drive array mirroring the first drive and the second drive, the first drive and the second drive including a first OS;
based on removing the first drive, remove the first OS from the first drive and include a plurality of partitions;
mount installation data on an installation partition of the plurality of partitions of the first drive, the installation data configured to install a second OS;
update a bootloader component of the computing device to include an installation option associated with the mounted installation data; and
install, via the installation option of the bootloader component, the second OS on the plurality of partitions of the first drive based on the installation data, whereby the computing device is enabled to boot to the second OS on the first drive or the first OS on the second drive.

2. The system of claim 1, the at least one memory and the computer program code configured to, with the at least one processor, further cause the at least one processor to:
receive instructions indicating to install the second OS on the second drive; and
in response to the received instructions, reconfigure the first drive to include partitions of a single drive upon which the second OS is installed and reconfigure the second drive to mirror the first drive based on the redundant drive array.

3. The system of claim 1, wherein the at least one memory and the computer program code configured to, with the at least one processor, further cause the at least one processor to:
upon receiving a request to complete an installation of the second OS on the first drive and the second drive:
format the second drive to be a mirror of the first drive using the redundant drive array;
copy data from the first drive into the second drive to synchronize the second drive with the first drive; and
update the bootloader component to include an option to boot into the second OS as installed on the first drive and the second drive and to remove an option to boot into the first OS for which the first drive and the second drive are no longer configured to use.

4. The system of claim 1, the at least one memory and the computer program code configured to, with the at least one processor, further cause the at least one processor to rebuild the bootloader component to support booting to the second OS on the first drive and the first OS on the second drive.

5. The system of claim 4, the at least one memory and the computer program code configured to, with the at least one processor, further cause the at least one processor to install the rebuilt bootloader component on the first drive and the second drive.

6. The system of claim 1, wherein
the second OS is installed on a first set of the plurality of partitions, wherein the first set of the plurality of partitions is configured to be a first virtual drive, and wherein a second set of the plurality of partitions is configured to be a second virtual drive that mirrors the first virtual drive using the redundant drive array.

7. The system of claim 1, wherein the at least one memory and the computer program code configured to, with the at least one processor, further cause the at least one processor to:
upon receiving a request to revert the installation of the second OS on the first drive back to the first OS:
format the first drive to be a mirror of the second drive using the redundant drive array;
copy data from the second drive to the first drive to synchronize the first drive with the second drive; and
update the bootloader component to include an option to boot into the first OS and to remove an option to boot into the second OS for which the first drive is no longer configured to use.

8. The system of claim 1, wherein the first drive and the second drive include boot partitions, root partitions, and application partitions, and wherein mounting installation data on the installation partition includes mounting an installation image and a kickstart file on the installation partition; and
wherein installing the second OS includes configuring, based on the kickstart file, a first two partitions of the plurality of partitions as boot partitions, configuring a second two partitions of the plurality of partitions as root partitions, and configuring a third two partitions of the plurality of partitions as application partitions on the first drive.

9. A computerized method for updating operating system (OS) software of a computing device with multiple redundant drives, the method comprising:
removing a first drive from a redundant drive array, the redundant drive array mirroring the first drive and a second drive, the first drive and the second drive including a first OS;
based on removing the first drive, removing the first OS from the first drive and including a plurality of partitions in the first drive;
mounting installation data on an installation partition of the plurality of partitions of the first drive, the installation data configured to install a second OS;
updating a bootloader component to include an installation option associated with the mounted installation data; and
installing, via the installation option of the bootloader component, the second OS on the plurality of partitions of the first drive based on the installation data, whereby the computing device is enabled to boot to the second OS on the first drive or the first OS on the second drive.

10. The computerized method of claim 9, further comprising:
receiving instructions indicating to install the second OS on the second drive; and
in response to the received instructions, reconfiguring the first drive to include partitions of a single drive upon which the second OS is installed and reconfiguring to second drive to mirror the first drive based on the redundant drive array.

11. The computerized method of claim 9, wherein the second OS is an updated version of the first OS.

12. The computerized method of claim 9, further comprising rebuilding the bootloader component to support booting to the second OS on the first drive and the first OS on the second drive.

13. The computerized method of claim 12, further comprising installing the rebuilt bootloader component on the first drive and the second drive.

14. The computerized method of claim 9, wherein installing the second OS on the plurality of partitions of the first drive based on the installation data includes installing a second redundant drive array mirroring the multiple virtual redundant drives of the first drive; and
the method further comprising disabling the second redundant drive array after installing the second OS.

15. The computerized method of claim 9, wherein the first drive and second drive include boot partitions, root partitions, and application partitions.

16. The computerized method of claim 15, wherein mounting installation data on the installation partition includes mounting an installation image and a kickstart file on the installation partition; and
wherein installing the second OS includes configuring, based on the kickstart file, a first two partitions of the plurality of partitions as boot partitions, configuring a second two partitions of the plurality of partitions as root partitions, and configuring a third two partitions of the plurality of partitions as application partitions on the first drive.

17. One or more computer storage media having computer-executable instructions for updating operating system (OS) software of a computing device with multiple redundant drives that, upon execution by a processor, cause the processor to at least:
remove a first drive from a redundant drive array, the redundant drive array mirroring the first drive and a second drive of the computing device, the first drive and the second drive including a first OS;
based on removing the first drive, remove the first OS from the first drive and include a plurality of partitions in the first drive;
mount installation data on an installation partition of the plurality of partitions of the first drive, the installation data configured to install an updated OS to multiple redundant drives;
update a bootloader component of the computing device to include an installation option associated with the mounted installation data; and
install, via the installation option of the bootloader component, the updated OS on the plurality of partitions of the first drive based on the installation data, whereby the computing device is enabled to boot to the updated OS on the first drive or the first OS on the second drive.

18. The one or more computer storage media of claim 17, the computer-executable instructions, upon execution by a processor, further causing the processor to:
receive instructions indicating to install the updated OS on the second drive; and
in response to the received instructions, reconfigure the first drive to include partitions of a single drive upon which the updated OS is installed and reconfiguring to second drive to mirror the first drive based on the redundant drive array.

19. The one or more computer storage media of claim 17, the computer-executable instructions, upon execution by a processor, further causing the processor to rebuild the bootloader component to support booting to the updated OS on the first drive and the first OS on the second drive.

20. The one or more computer storage media of claim 17, wherein mounting installation data on the installation partition includes mounting an installation image and a kickstart file on the installation partition; and
wherein installing the updated OS includes configuring, based on the kickstart file, a first two partitions of the plurality of partitions as boot partitions, configuring a second two partitions of the plurality of partitions as root partitions, and configuring a third two partitions of the plurality of partitions as application partitions on the first drive.
